(19) United States
(12) Patent Application Publication
(10) Pub. No.: US 2003/0024447 A1
(43) Pub. Date: Feb. 6, 2003

(54) Apparatus for closing the open end of a foot on a piece of tubular furniture

(76) Inventors: Charles Arthur Risdall, Dallas, TX (US); William Thomas Risdall, Plano, TX (US)

Correspondence Address: THOMPSON COBURN, LLP, ONE FIRSTAR PLAZA, SUITE 3500, ST LOUIS, MO, 63101, US

(21) Appl. No.: 09/922,057

(22) Filed: Aug. 3, 2001

(51) Int. Cl. F16M 11/24

(52) U.S. Cl. 108/153.1; 108/50.01; 248/188.2; 248/188.4

(57) ABSTRACT

An apparatus for closing the open end of a foot on a piece of tubular furniture having a cap (10) for a piece of tubular furniture (20), a butt portion (22), a bottom (24), an inner wall (26), and an outer wall (28). A threaded insert (30), preferably metallic, is molded into bottom portion (24). When inserted into a foot (15) of a piece of tubular furniture (20), inner wall (26) and outer wall (28) engage foot (15) in a two-sided friction fit, and a threaded glide or caster (40) is inserted through foot (15) and threaded insert (30), further securing cap (10) to foot (15) and providing easy movement and leveling of furniture (20).

### Cross-Reference to Related Applications

Not Applicable.

### STATEMENT REGARDING FEDERALLY SPONSORED RESEARCH OR DEVELOPMENT

Not Applicable.

1. Field of the Invention

The present invention relates generally to furniture made out of a hollow, tubular material (“tubular furniture”). More specifically, the present invention relates to a cap for use in sealing the foot of a piece of tubular furniture.

2. Background of the Invention

Student furniture, such as the desks found in a typical classroom, is often made out of a hollow, tubular material such as steel. The ends of the furniture are thus inherently open with edges exposed, presenting an unattractive, unfinished appearance. Additionally, this open-ended configuration presents a safety hazard, as schoolchildren can get their fingers stuck inside the tubular material or become cut on the unfinished edges of the material.

To remedy the problem, most tubular furniture incorporates a cap inserted into the ends of the tubular material. The cap lends the furniture a finished appearance and prevents students from injuring themselves on the tubular material. These caps typically attach to the tubular material via a one-sided friction fit, though they may also be glued into the tubular material. Additionally, so that the furniture can be easily moved around, a caster or glide is typically attached directly to the foot of the furniture, for example by welding the glide to the metal foot of the furniture.

However, existing caps do not provide a permanent solution to the problems posed by tubular furniture. Ordinary use, and especially the rigors of classroom use, can leave the tubular material misshapen or otherwise damaged. This, in turn, will cause the friction fit of the cap in the tubular material to fail such that the cap breaks free and becomes permanently lost, leaving a once again hazardous and unattractive piece of furniture. Furthermore, casters and glides that are attached directly to the foot of the furniture have a similar tendency to become misshapen, leaving the furniture unstable and difficult to move, as well as difficult to repair where the caster or glide is permanently attached to the piece of furniture.

### SUMMARY OF THE INVENTION

It is in view of the above problems that the present invention was developed. The present invention is an apparatus for closing the open end of a foot on a piece of tubular furniture that attaches to the furniture via both a two-sided friction fit and a threaded caster or glide. A butt portion gives the tubular furniture a finished appearance and improves the safety of the furniture, while inner and outer wall portions engage the tubular furniture in a two-sided friction fit. A threaded insert molded into a bottom portion of the cap allows a threaded caster or glide to be inserted through the tubular furniture and the cap, securely attaching the cap to the furniture. In addition to providing easy movement and an additional locking mechanism for the cap, the threaded glide or caster also allows the piece of furniture to be leveled on any surface.

The present invention provides an apparatus for closing an open end of a piece of tubular furniture that cannot easily become detached from the furniture under normal circumstances.

The present invention provides an apparatus for closing an open end of a piece of tubular furniture that will not become detached from the furniture if the furniture becomes damaged or misshapen.

The present invention provides an apparatus for closing an open end of a piece of tubular furniture that integrates a threaded caster or glide as an additional means of securing the cap to the furniture.

Further advantages of the present invention will be apparent from the description below with reference to the accompanying drawings in which like numbers indicate like elements.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a perspective view of a student desk incorporating the present invention;

FIG. 2 is a side sectional view of the apparatus attached to the foot of a piece of tubular furniture; and

FIG. 3 is a bottom view of the apparatus attached to the foot of a piece of tubular furniture.

### DETAILED DESCRIPTION OF THE INVENTION

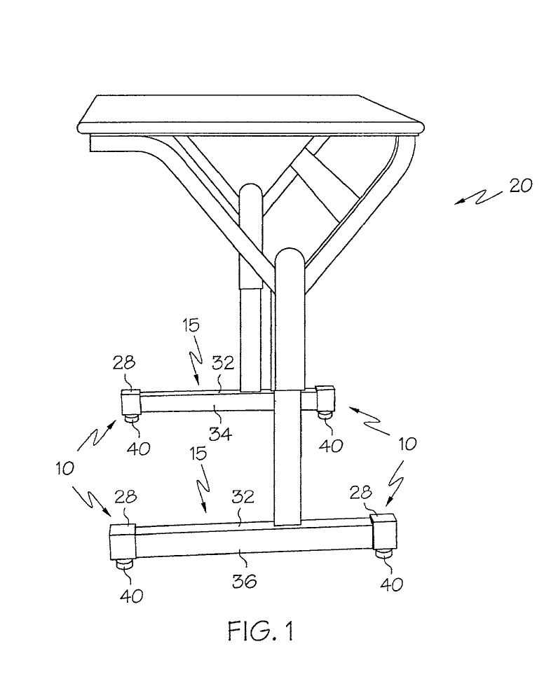

As shown in FIGS. 1 through 3, an apparatus for closing the open end of a foot 15 of a piece of tubular furniture 20 includes a cap 10, a butt portion 22, a bottom 24, an inner wall 26, 20 an outer wall 28, and a threaded insert 30. Threaded insert 30 is molded into bottom 24 and is metallic in the preferred embodiment of the invention. Inner wall 26 and outer wall 28 are spaced apart so as to engage foot 15 in a two-sided friction fit. Bottom 24, inner wall portion 26, and outer wall 28 all extend from butt portion 22.

In the embodiment of the invention illustrated by the figures, cap 10 and foot 15 are rectangular in shape when viewed end-on. Inner wall 26 and outer wall 28 extend from three of the four sides of butt portion 22, and bottom 24 extends from the fourth side, all in a plane substantially perpendicular to that of butt portion 22. However, it will be obvious to one skilled in the art that cap 10 can be adapted to fit any other shape of foot 15.

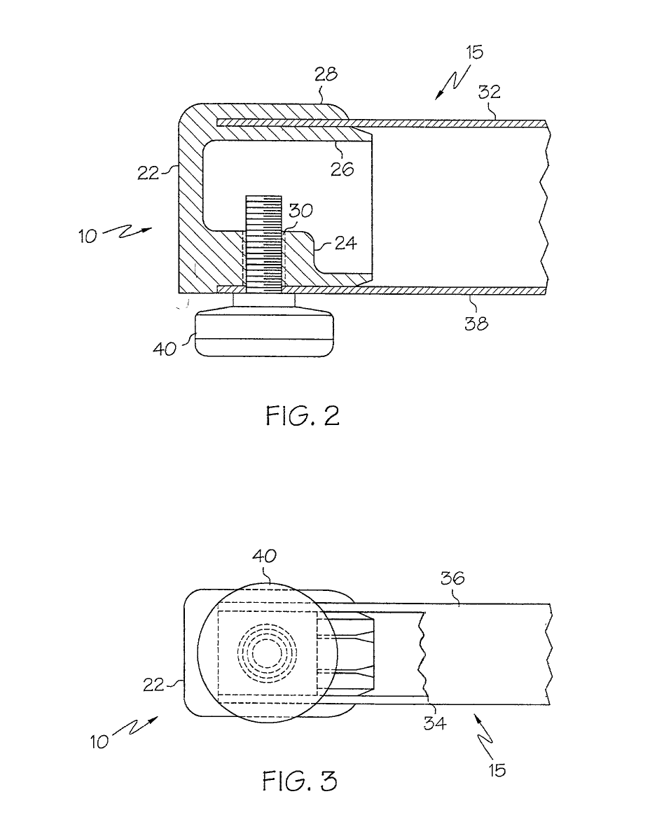

When cap 10 is inserted into foot 15, butt portion 22 covers the exposed end of foot 15, giving furniture 20 a finished appearance and making it safe for use by students of all ages. Inner wall 26 and outer wall 28 engage three sides 32 (best seen in FIG. 2), 34, and 36 (best seen in FIG. 3) of foot 15 in a two-sided friction fit, while bottom 24 lies along the interior of a fourth side 38 to form a single-sided friction fit. The two-sided friction fit together with a single-sided friction fit keeps cap 10 more securely attached to foot 15 than the one-sided friction fit of existing caps. However, it is pointed out that the single-sided friction fit between bottom 24 and fourth side 38 is not required to attach cap 10 to foot 15.

To further secure cap 10 to foot 15, a threaded member 40, such as a caster or a glide (shown), is then inserted through side 38 and operatively engaged with threaded insert 30, keeping cap 10 securely attached to foot 15 even if the two-sided friction fit fails. Threaded member 40 also allows furniture 20 to be easily moved. In addition, by screwing and unscrewing threaded member 40 in small increments, furniture 20 can be leveled on any surface. Furthermore, a threaded member 40 is much easier to repair or replace than those movement means permanently connected to tubular furniture.

As various modifications could be made in the constructions and methods herein described and illustrated without departing from the scope of the invention, it is intended that all matter contained in the foregoing description or shown in the accompanying drawings shall be interpreted as illustrative rather than limiting. Additionally, it should be obvious that the present invention is not limited in its application to student desks, but can also be used at the foot of any piece of tubular furniture. Thus, the breadth and scope of the present invention should not be limited by any of the above-described exemplary embodiments, but should be defined only in accordance with the following claims appended hereto and their equivalents.

What is claimed is:

1. An apparatus for closing an open end of a piece of tubular furniture comprising:
(a) a cap having a butt portion and an attachment portion, said butt portion being opposite said attachment portion; and
(b) said attachment portion having an inner wall and an outer wall spaced apart such that said inner wall is adapted to contact an inside of the open end and said outer wall is adapted to contact an outside of the open end.

2. The apparatus of claim 1 wherein the attachment portion further comprises a threaded insert.

3. The apparatus of claim 2 wherein said threaded insert is metallic.

4. The apparatus of claim 2 further comprising a threaded member.

5. The apparatus of claim 4 wherein said threaded member is a caster.

6. The apparatus of claim 4 wherein said threaded member is a glide.

7. An apparatus for closing an open end of a tubular foot, the tubular foot aligned parallel to the ground and supporting a piece of furniture, said apparatus comprising:
(a) a cap having a butt portion and an attachment portion, said butt portion being opposite said attachment portion,
said attachment portion having a top, a bottom, a first side and a second side,
said bottom of said attachment portion having a threaded insert, said attachment portion defining an inner wall and an outer wall, said inner wall and said outer wall spaced apart such that said apparatus is adapted to engage the open end of the tubular foot in a two-sided friction fit; and
(b) a threaded member cooperatively engaged with said threaded insert.

8. The apparatus of claim 7 wherein said threaded insert is metallic.

9. The apparatus of claim 7 wherein said threaded member is a caster.

10. The apparatus of claim 7 wherein said threaded member is a glide.
